(19) United States
(12) Patent Application Publication
(10) Pub. No.: US 2014/0351612 A1
(43) Pub. Date: Nov. 27, 2014

(54) INFORMATION PROCESSING METHOD AND ELECTRONIC DEVICE

(71) Applicant: LENOVO (BEIJING) LIMITED, Beijing (CN)

(72) Inventors: Ying Sun, Beijing (CN); Dongzhe Liu, Beijing (CN); Zhigang Na, Beijing (CN)

(73) Assignee: LENOVO (BEIJING) LIMITED, Beijing (CN)

(21) Appl. No.: 14/228,335

(22) Filed: Mar. 28, 2014

(30) Foreign Application Priority Data
May 23, 2013 (CN) 201310195758.0

(51) Int. Cl. G06F 1/32; G06F 1/20

(52) U.S. Cl. CPC G06F 1/3206; G06F 1/206
USPC 713/320

(57) ABSTRACT

The present invention discloses an information processing method and an electronic device. The method is applied in an electronic device including a first heating element and a first cooling apparatus, and comprises steps of: detecting and obtaining, at a first instant, first posture information indicating that the electronic device is in a first posture; and detecting and obtaining first actual power of the first heating element; determining first cooling efficiency corresponding to the first posture information, based on a correspondence between the posture information and cooling efficiency of the first cooling apparatus; deciding whether the first actual power is larger than first standard power of the first heating element corresponding to the first cooling efficiency, so as to obtain a decision result; adjusting power of the first heating element from the first actual power to the first standard power, when the decision result indicates that the first actual power is larger than the first standard power.

### TECHNICAL FIELD

The present disclosure relates to the communication techniques, and particularly, to an information processing method and an electronic device.

### BACKGROUND

With continuous development of science and technology, electronic devices have also been rapidly developed, and types of electronic products are becoming more and more. People also enjoy various conveniences brought by scientific developments. Now, people may use various types of the electronic devices for enjoying a comfortable life brought by technological developments. For example, different function operations may be performed by various electronic devices. For example, operations such as working, surfing, playing games, programming etc. may be performed by using a notebook, and operations such as making calls, listening to music, voice chatting etc. may be performed by using a smart phone.

Generally in the prior art, when a user is using an electronic device, the electronic device may be placed in different postures according to different usage requirements or modes. For example, for a 360°-rotatable notebook, there may be a notebook posture corresponding to a traditional notebook usage mode, a tablet posture corresponding to a tablet computer mode, etc. However, the structure and the mechanical design of a cooling apparatus are designed in the traditional notebook mode. When the electronic device is in the tablet computer mode or other modes, its placement posture may be different from the notebook posture, which will reduce cooling efficiency of the cooling apparatus, e.g., reduce a maximum cooling power of a heat pipe in the notebook. Thus, when a heating power of a CPU is greater than the maximum cooling power of the heat pipe, the heat pipe will dry out (Dry out) in a very short period of time and lose its ability of transferring heat, which leads to an instantaneous rapid rise of a temperature within the electronic device, thereby causing overheat of the system. Thermal resistance of the heat pipe is shown in FIG. 1.

In the prior art, another cooling design, called overheat protection, is proposed for solving defects of such a cooling apparatus. The overheat protection may be illustrated as follows. When the electronic device detects that the temperature of the heat generated by heating elements is higher than a preset value, the electronic device will force the system to reduce its frequency or shut down; wherein when the system overheat is caused by the dry-out of the heat pipe, the system overheat protection mechanism may force the system to reduce its frequency, resulting in a reduction of the heating power of the system; and when the heating power of the system is reduced below a maximum power value transferable by the heat pipe, the heat pipe may resume its work. At the time, the thermal resistance of the heat pipe may be reduced rapidly in the very short period of time, and the temperature of chips within the electronic device may be lowered. When the temperature falls below a frequency reduction temperature point, the CPU may resume a normal frequency.

However, the inventor found at least technical problems as follows during implementation of technical solutions according to embodiments of the present invention.

1. Since the problem of insufficient heat dissipation of the cooling apparatus is solved by the overheat protection mechanism in the prior art, the frequency reduction may occur when an internal temperature of the system rises and the system may resume to the normal frequency accordingly when the temperature resumes to a normal state. Such repeated changes may cause the system unstable.

2. Since the above technical problem that the system is unstable exists, the electronic device may be caused to be in a state of repeated power on/off. Thus, there is a technical problem that the electronic device is started up frequently, which may further bring a negative effect on usage of the user and bring degraded usage experience to the user.

### SUMMARY OF INVENTION

Embodiments of the present application provide an information processing method and an electronic device, capable of solving the technical problem in which a temperature of the electronic device is controlled to be not too high by frequency reduction or shut-down so that there are repeated vibrations in the system of the electronic device and thus the system is not stable. Therefore, the electronic device may be controlled effectively so that there may not be repeated vibrations in the system, thereby the system may be kept stable.

In an aspect, an embodiment of the present application provides an information processing method applied in an electronic device including a first heating element and a first cooling apparatus, the method comprising steps of: detecting and obtaining, at a first instant, first posture information indicating that the electronic device is in a first posture; and detecting and obtaining first actual power of the first heating element; determining first cooling efficiency corresponding to the first posture information, based on a correspondence between the posture information and cooling efficiency of the first cooling apparatus; deciding whether the first actual power is larger than first standard power of the first heating element corresponding to the first cooling efficiency, so as to obtain a decision result; adjusting power of the first heating element from the first actual power to the first standard power when the decision result indicates that the first actual power is larger than the first standard power.

Further, the first cooling apparatus comprises a heat source end and a condensing end connected to the heat source end, the first posture information being relative position relationship information of the heat source end and the cooling end at the first instant.

Further, when the position of the heat source end relative to the position of the cooling end is a position above a horizontal plane, the first posture information is positive direction information representing that the relative position relationship information of the heat source end and the condensing end is in a positive direction; and when the position of the heat source end relative to the position of the cooling end is a position under a horizontal plane, the first posture information is negative direction information representing that the relative position relationship information of the heat source end and the condensing end is in a negative direction.

Further, when the first posture information is the negative direction information, the step of determining the first cooling efficiency corresponding to the first posture information, based on the correspondence between the posture information and the cooling efficiency of the first cooling apparatus comprises a step of determining the first cooling efficiency corresponding to the negative direction information, based on the correspondence between the negative direction information and the cooling efficiency of the first cooling apparatus.

Further, the step of deciding whether the first actual power is larger than first standard power of the first heating element corresponding to the first cooling efficiency so as to obtain a decision result comprises steps of: obtaining the first standard efficiency of the first heating element corresponding to the first cooling efficiency; and deciding whether the first actual power is larger than the first standard power, so as to obtain the decision result.

Further, when the first cooling efficiency is a maximum cooling power of the first cooling apparatus, the step of obtaining the first standard power of the first heating element corresponding to the first cooling efficiency comprises a step of obtaining the first standard power of the first heating element corresponding to the maximum cooling power by looking up in a correspondence table between the cooling power and the standard power of the first heating element.

Further, the step of adjusting the power of the first heating element from the first actual power to the first standard power when the decision result indicates that the first actual power is larger than the first standard power comprises steps of: deciding whether the first actual power is less than the maximum cooling power when the decision result indicates that the first actual power is larger than the first standard power; and adjusting the power of the first heating element from the first actual power to the first standard power when the first actual power is less than the maximum cooling power.

In another aspect, an embodiment of the present application provides an electronic device comprising a first heating element and a first cooling apparatus, and further comprising: a detection and obtaining unit, configured to detect and obtain, at a first instant, first posture information indicating that the electronic device is in a first posture; and to detect and obtain first actual power of the first heating element; a determination unit, configured to determine first cooling efficiency corresponding to the first posture information based on a correspondence between the posture information and cooling efficiency of the first cooling apparatus; a decision unit, configured to decide whether the first actual power is larger than first standard power of the first heating element corresponding to the first cooling efficiency, so as to obtain a decision result; an adjustment unit, configured to adjust power of the first heating element from the first actual power to the first standard power when the decision result indicates that the first actual power is larger than the first standard power.

Further, the first cooling apparatus further comprises: a heat source end; and a condensing end connected to the heat source end; wherein the first posture information is relative position relationship information of the heat source end and the cooling end at the first instant.

Further, when the position of the heat source end relative to the position of the cooling end is a position above a horizontal plane, the first posture information is positive direction information representing that the relative position relationship information of the heat source end and the condensing end is in a positive direction; when the position of the heat source end relative to the position of the cooling end is a position under a horizontal plane, the first posture information is negative direction information representing that the relative position relationship information of the heat source end and the condensing end is in a negative direction.

Further, when the first posture information is the negative direction information, the determination unit is further configured to determine the first cooling efficiency corresponding to the negative direction information, based on the correspondence between the negative direction information and the cooling efficiency of the first cooling apparatus.

Further, the decision unit further comprises: a first obtaining unit, configured to obtain the first standard efficiency of the first heating element corresponding to the first cooling efficiency; a first decision sub-unit, configured to decide whether the first actual power is larger than the first standard power, so as to obtain the decision result.

Further, when the first cooling efficiency is a maximum cooling power of the first cooling apparatus, the first obtaining unit is further configured to obtain the first standard power of the first heating element corresponding to the maximum cooling power by looking up in a correspondence table between the cooling power and the standard power of the first heating element.

Further, the adjustment unit particularly comprises: a first decision sub-unit, configured to decide whether the first actual power is less than the maximum cooling power when the decision result indicates that the first actual power is larger than the first standard power; a first adjustment sub-unit, configured to adjust the power of the first heating element from the first actual power to the first standard power when the first actual power is less than the maximum cooling power.

One or more technical solutions provided in the embodiments of the present application have at least technical effects or advantages as follows.

1. Since it is decided whether the first actual power of the first heating element is larger than the first standard power of the first heating element corresponding to the first cooling efficiency and the power of the first heating element is adjusted from the first actual power to the first standard power when the first actual power is larger than the first standard power, the problem (i.e., since the problem of insufficient heat dissipation of the cooling apparatus is solved by the overheat protection mechanism in the prior art, the frequency reduction may occur when an internal temperature of the system rises and the system may resume to the normal frequency accordingly when the temperature resumes to a normal state. Such repeated changes may cause the system unstable) in the prior art may be solved efficiently. Thus, the repeated vibrations may not occur in the system by effectively controlling the electronic device, thereby stability of the system may be guaranteed.

2. Since it is decided whether the first actual power is less than the maximum cooling power of the first cooling apparatus when the first actual power of the first heating element is larger than the first standard power of the first heating element corresponding to the first cooling efficiency, and the first actual power is adjusted timely to the first standard power when the first actual power is less than the maximum cooling power, the technical problem (i.e., the system is unstable and the electronic device may be caused to be in a state of repeated power on/off, thereby there is a technical problem that the electronic device is started up frequently, which may further bring a negative effect on usage of the user and bring degraded usage experience to the user) in the prior art may be solved efficiently. Thus, the system may be avoided from being restarted when the power of the first heating element in the electronic device reaches the maximum cooling power. The system of the electronic device may be kept in the normal state, and the phenomenon of repeatedly restarting the system may not occur.

### BRIEF DESCRIPTION OF THE DRAWINGS

FIG. 1 shows a coordinate graph of a variation of heat resistance of a heat pipe in the prior art formed by changes of orientation angles of a cooling apparatus;

FIG. 2 shows a flowchart of an information processing method in an embodiment of the present application;

FIG. 3 shows a structure diagram of a first cooling apparatus in an embodiment of the present application;

FIG. 4 shows a schematic diagram of a relative position relationship of a heat source end and a condensing end in a first cooling apparatus in an embodiment of the present application;

FIG. 5 shows a coordinate graph of cooling efficiency of a first cooling apparatus in an embodiment of the present application in different posture information states;

FIG. 6 shows a module diagram of an electronic device in an embodiment of the present application.

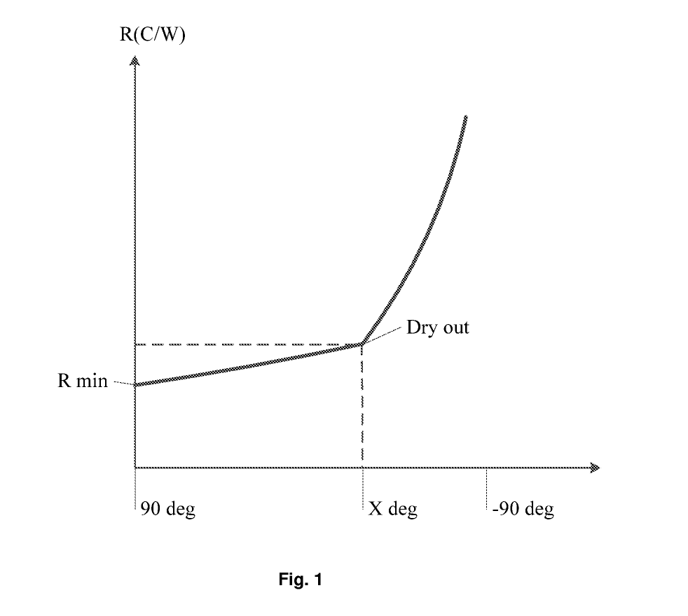

### DETAILED DESCRIPTION

Embodiments of the present application provide an information processing method and an electronic device, capable of solving the technical problem in which a temperature of the electronic device is controlled to be not too high by frequency reduction or shut-down so that there are repeated vibrations in the system of the electronic device and thus the system is not stable. Therefore, the electronic device may be controlled effectively so that there may not be repeated vibrations in the system, thereby the system may be kept stable.

A general concept of technical solutions in the embodiments of the present application for solving the above technical problem that the system is unstable may be illustrated as follows.

The present scheme proposes, for characteristics variation of the heat resistance of the heat pipe in different angles, that standard heating power matched with cooling power of the heat pipe in the different angles may be found according to the cooling power; if the actual heating power of the electronic device is larger than the standard heating power, current actual heating power of the heating element may be adjusted to be equal to a value of the standard heating power. Therefore, it may be ensured that the phenomenon of frequency reduction or shut-down of the system due to extremely high temperature of the heating element may not occur in the system, thereby the stability of the system may be effectively guaranteed.

Hereinafter, the above technical solutions will be described in detail in connection with the drawings and particular embodiments, in order to better understand the above technical solutions

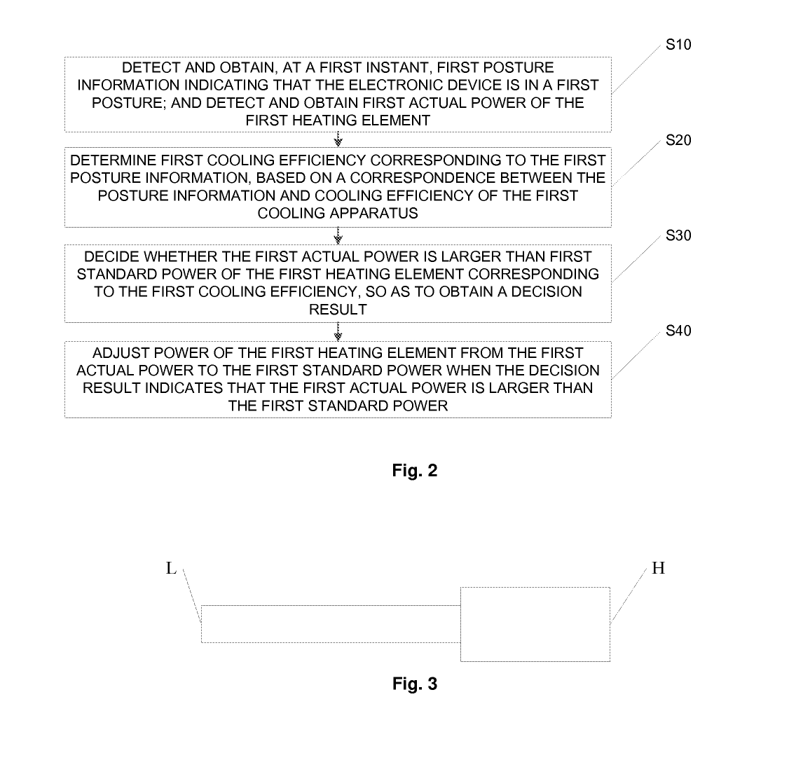

An embodiment of the present application provides an information processing method applied in an electronic device including a first heating element and a first cooling apparatus. As shown in FIG. 2, the method may comprise:

Step S10 of detecting and obtaining, at a first instant, first posture information indicating that the electronic device is in a first posture; and detecting and obtaining first actual power of the first heating element;

Step S20 of determining first cooling efficiency corresponding to the first posture information, based on a correspondence between the posture information and cooling efficiency of the first cooling apparatus;

Step S30 of deciding whether the first actual power is larger than first standard power of the first heating element corresponding to the first cooling efficiency, so as to obtain a decision result; and

Step S40 of adjusting power of the first heating element from the first actual power to the first standard power when the decision result indicates that the first actual power is larger than the first standard power.

In step S10, the first cooling apparatus comprises a heat source end H and a condensing end L connected to the heat source end H, the first posture information being relative position relationship information of the heat source end H and the condensing end L at the first instant. As shown in FIG. 3, FIG. 3 is a structure of the cooling apparatus.

In the present embodiment of the application, the first heating element may be a CPU, and the first cooling apparatus may be a heat pipe, a cooling fan etc.

In step S10, the posture information of the electronic device may be detected at the first instant. The posture information represents the relative position relationship of the heat source end H and the condensing end L of the first cooling apparatus arranged inside the electronic device. Then, the first actual power of the first heating element may be obtained. It is not difficult to obtain the first actual power of the heating element. From an intuitive view, obtaining the relative position of the heat source end H and the cooling end L is to obtain information on an angle between the orientation of the electronic device and the horizontal plane.

Step S20 may be performed after the posture information and the actual power of the heating element have been obtained. The first cooling efficiency corresponding to the first posture information may be determined based on the correspondence between the posture information and cooling efficiency of the first cooling apparatus.

Hereinafter, it will be described in detail how to obtain the actual power of the heating element according to the relative position relationship of the heat source end H and the condensing end L of the cooling apparatus.

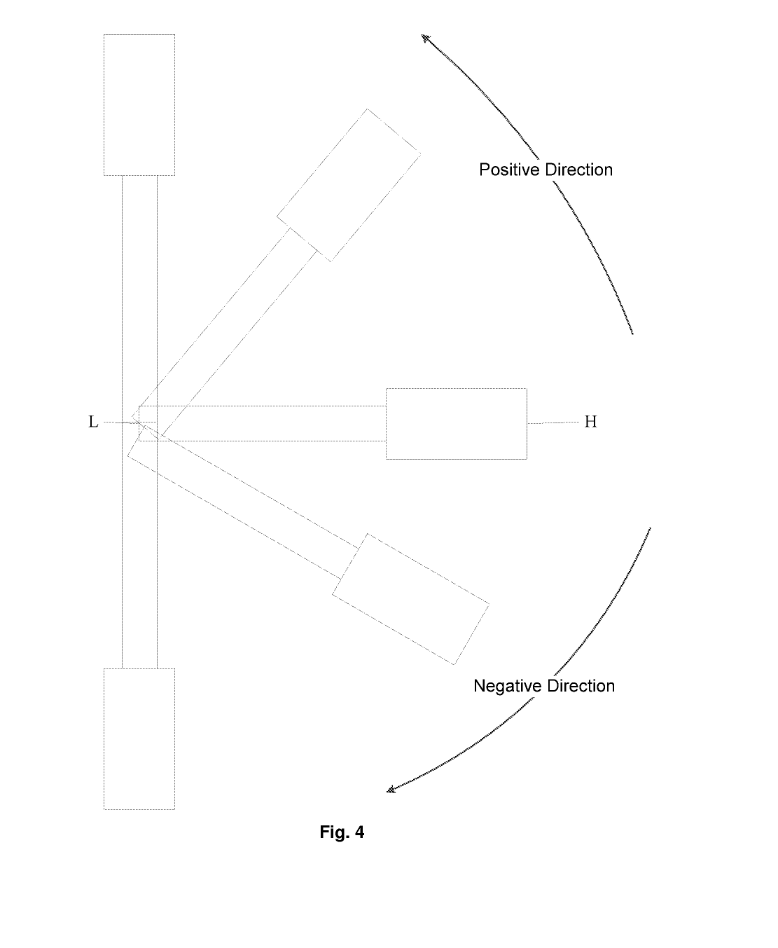

As shown in FIG. 4, when the heat source end H and the condensing end L are disposed at two ends in the horizontal position, the heat source end H is located at the right end, and the condensing end L is located at the left end. When the position of the heat source end H relative to the position of the condensing end L is a position above the horizontal plane, the first posture information is positive direction information representing that the relative position relationship information of the heat source end H and the condensing end L is in a positive direction. In this case, it is not necessary to adjust the power of the first heating element, since the electronic device is currently in a correct orientation posture. Working efficiency of the first cooling apparatus may satisfy requirement of the first heating element completely.

When the position of the heat source end H relative to the position of the cooling end L is a position under the horizontal plane, the first posture information is negative direction information representing that the relative position relationship information of the heat source end H and the condensing end L is in a negative direction. In particular, when the first posture information is the negative direction information, the step of determining the first cooling efficiency corresponding to the first posture information based on the correspondence between the posture information and the cooling efficiency of the first cooling apparatus is a step of determining the first cooling efficiency corresponding to the negative direction information, based on the correspondence between the negative direction information and the cooling efficiency of the first cooling apparatus.

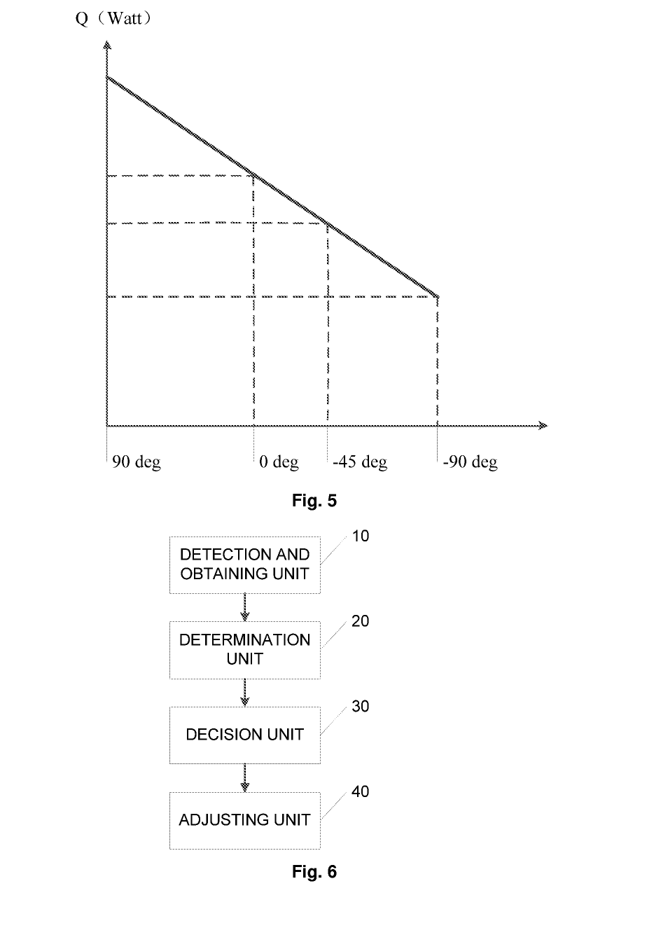

In a specific implementation, as can be seen from FIG. 5, e.g., when the positions of the heat source end H and the condensing end L are relatively in a horizontal direction, the angle between the first cooling apparatus and the horizontal plane is 0°. Here, corresponding power of the first cooling apparatus is Q1. When the heat source end H is rotated around the condensing end L which is used as a center of a circle, corresponding power of the first cooling apparatus is Q2 when the heat source end H is rotated so that the angle between the cooling apparatus and the horizontal plane is −45°. Q2 is significantly smaller than Q1. It may be seen that the larger the negative direction angle of the first cooling apparatus is, the smaller the corresponding power of the cooling apparatus is.

Cooling efficiency of the first cooling apparatus corresponding to different negative direction angles may be clearly seen from FIG. 5. Next, step S30 is performed to decide whether the first actual power is larger than the first standard power of the first heating element corresponding to the first cooling efficiency, so as to obtain a decision result.

When the first cooling efficiency is the maximum cooling power of the first cooling apparatus, the step of obtaining the first standard power of the first heating element corresponding to the first cooling efficiency is a step of obtaining the first standard power of the first heating element corresponding to the maximum cooling power by looking up in a correspondence table between the cooling power and the standard power of the first heating element.

In a specific implementation, the cooling efficiencies of different negative direction angles may be obtained from FIG. 5. With respect to the cooling efficiencies of the different negative direction angles, the first standard heating power corresponding to the current cooling efficiency may be obtained. Here, the first standard heating power is heating power which satisfies the heating efficiency corresponding to the current negative direction angle. The first standard heating power is slightly less than the cooling efficiency, which may be obtained by looking up in a table.

After the first standard power is obtained, the first actual power obtained from S10 may be compared with the obtained first standard power. When the first actual power is 30W and the first standard power is 35W, the first actual power is less than the first standard power, and thus a result of the first actual power being less than the first standard power may be obtained; while when the first actual power is 34W and the first standard power is 32W, the first actual power is larger than the first standard power, and thus a result of the first actual power being larger than the first standard power may be obtained.

After the comparison result is obtained, step S40 may be performed to adjust the power of the first heating element from the first actual power to the first standard power when the decision result indicates that the first actual power is larger than the first standard power.

In this step, when the decision result indicates that the first actual power is larger than the first standard power, it is decided whether the first actual power is less than the maximum cooling power; and when the first actual power is less than the maximum cooling power, the power of the first heating element is adjusted from the first actual power to the first standard power.

In a specific implementation, if the obtained result indicates that the first actual power is larger than the first standard power, it needs to be further decided whether the first actual power is less than the current maximum cooling power since the first standard power is slightly less than the cooling power. The reason is that if the first actual power is larger than the current maximum cooling power, the cooling apparatus is easily burned out; while if the currently obtained first actual power is less than the current maximum cooling power, the current power of the heating element may be adjusted to a value of the first standard power, so as to keep the power of the heating element not to be too large to burn out the cooling element which may cause the system to stop working and bring degraded usage experience to the user.

Therefore, the electronic device may be kept in the normal state for a long time by maintaining the actual power of the heating element in a standard state adapted to the cooling efficiency, and also the stability of the system may be guaranteed.

An embodiment of the present application also provides an electronic device comprising a first heating element and a first cooling apparatus. As shown in FIG. 6, the electronic device further comprises: a detection and obtaining unit 10, configured to detect and obtain, at a first instant, first posture information indicating that the electronic device is in a first posture; and for detecting and obtaining first actual power of the first heating element; a determination unit 20, configured to determine first cooling efficiency corresponding to the first posture information based on a correspondence between the posture information and cooling efficiency of the first cooling apparatus; a decision unit 30, configured to decide whether the first actual power is larger than first standard power of the first heating element corresponding to the first cooling efficiency, so as to obtain a decision result; an adjustment unit 40, configured to adjust power of the first heating element from the first actual power to the first standard power when the decision result indicates that the first actual power is larger than the first standard power.

Further, the first cooling apparatus particularly comprises: a heat source end H; and a condensing end L connected to the heat source end H; wherein the first posture information is relative position relationship information of the heat source end H and the cooling end L at the first instant.

Further, when a position of the heat source end H relative to a position of the cooling end L is a position above a horizontal plane, the first posture information is positive direction information representing that the relative position relationship information of the heat source end H and the condensing end L is in a positive direction; when the position of the heat source end H relative to the position of the cooling end L is a position under a horizontal plane, the first posture information is negative direction information representing that the relative position relationship information of the heat source end H and the condensing end L is in a negative direction.

Further, when the first posture information is the negative direction information, the determination unit is further configured to determine the first cooling efficiency corresponding to the negative direction information based on the correspondence between the negative direction information and the cooling efficiency of the first cooling apparatus.

Further, the decision unit 30 further comprises: a first obtaining unit, configured to obtain the first standard efficiency of the first heating element corresponding to the first cooling efficiency; a first decision sub-unit, configured to decide whether the first actual power is larger than the first standard power, so as to obtain the decision result.

Further, when the first cooling efficiency is a maximum cooling power of the first cooling apparatus, the first obtaining unit is further configured to obtain the first standard power of the first heating element corresponding to the maximum cooling power by looking up in a correspondence table between the cooling power and the standard power of the first heating element.

Further, the adjustment unit 40 further comprises: a first decision sub-unit, configured to decide whether the first actual power is less than the maximum cooling power when the decision result indicates that the first actual power is larger than the first standard power; a first adjustment sub-unit, configured to adjust the power of the first heating element from the first actual power to the first standard power when the first actual power is less than the maximum cooling power.

One or more technical solutions provided in the embodiments of the present application have at least technical effects or advantages as follows.

1. Since it is decided whether the first actual power of the first heating element is larger than the first standard power of the first heating element corresponding to the first cooling efficiency and the power of the first heating element is adjusted from the first actual power to the first standard power when the first actual power is larger than the first standard power, the problem (i.e., since the problem of insufficient heat dissipation of the cooling apparatus is solved by the overheat protection mechanism in the prior art, the frequency reduction may occur when an internal temperature of the system rises and the system may resume to the normal frequency accordingly when the temperature resumes to a normal state. Such repeated changes may cause the system unstable) in the prior art may be solved efficiently. Thus, the repeated vibrations may not occur in the system by effectively controlling the electronic device, thereby stability of the system may be guaranteed.

2. Since it is decided whether the first actual power is less than the maximum cooling power of the first cooling apparatus when the first actual power of the first heating element is larger than the first standard power of the first heating element corresponding to the first cooling efficiency, and the first actual power is adjusted timely to the first standard power when the first actual power is less than the maximum cooling power, the technical problem (i.e., the system is unstable and the electronic device may be caused to be in a state of repeated power on/off, thereby there is a technical problem that the electronic device is started up frequently, which may further bring a negative effect on usage of the user and bring degraded usage experience to the user) in the prior art may be solved efficiently. Thus, the system may be avoided from being restarted when the power of the first heating element in the electronic device reaches the maximum cooling power. The system of the electronic device may be kept in the normal state, and the phenomenon of repeatedly restarting the system may not occur.

It can be appreciated by those skilled in the art that the embodiments of the present invention can be implemented as a method, a system or a computer program product. The present invention may include pure hardware embodiments, pure software embodiments and any combination thereof. Also, the present invention may include a computer program product implemented on one or more computer readable storage medium (including, but not limited to, magnetic disk storage, CD-ROM, optical storage) containing computer readable program codes.

The present invention have been described with reference to the flowcharts and/or block diagrams of the method, device (system) and computer program product according to the embodiments of the present invention. It can be appreciated that each process and/or block in the flowcharts and/or block diagrams, or any combination thereof, can be implemented by computer program instructions. Such computer program instructions can be provided to a general computer, a dedicated computer, an embedded processor or a processor of any other programmable data processing device to constitute a machine, such that the instructions executed by the computer or the processor of any other programmable data processing device can constitute means for implementing the functions specified by one or more processes in the flowcharts and/or one or more blocks in the block diagrams.

These computer program instructions can also be stored in a computer readable memory that can direct a computer or any other programmable data processing device to operate in a particular way. Thus, the instructions stored in the computer readable memory constitute an article of manufacture including instruction means for implementing the functions specified by one or more processes in the flowcharts and/or one or more blocks in the block diagrams.

These computer program instructions can also be loaded onto a computer or any other programmable data processing device, such that the computer or the programmable data processing device can perform a series of operations/steps to achieve a computer-implemented process. In this way, the instructions executed on the computer or the programmable data processing device can provide steps for implementing the functions specified by one or more processes in the flowcharts and/or one or more blocks in the block diagrams.

Although preferred embodiments of the present invention have been described, the skilled in the art may make additional variations and modifications on these embodiments once he knows the basic inventive concept. Therefore, the appended claims intend to be explained as including the preferred embodiments and all of variations and modifications falling into the scope of the present invention.

Obviously, various modifications and variants can be made to the present invention by those skilled in the art without departing from the spirit and scope of the present invention. Therefore, these modifications and variants are to be encompassed by the present invention if they fall within the scope of the present invention as defined by the claims and their equivalents.

I/we claim:

1. An information processing method applied in an electronic device including a first heating element and a first cooling apparatus, comprising steps of:
detecting and obtaining, at a first instant, first posture information indicating that the electronic device is in a first posture; and detecting and obtaining first actual power of the first heating element;
determining first cooling efficiency corresponding to the first posture information, based on a correspondence between the posture information and cooling efficiency of the first cooling apparatus;
deciding whether the first actual power is larger than first standard power of the first heating element corresponding to the first cooling efficiency, so as to obtain a decision result;
adjusting power of the first heating element from the first actual power to the first standard power when the decision result indicates that the first actual power is larger than the first standard power.

2. The method according to claim 1, wherein the first cooling apparatus comprises a heat source end and a condensing end connected to the heat source end, the first posture information being relative position relationship information of the heat source end and the cooling end at the first instant.

3. The method according to claim 2, wherein when the position of the heat source end relative to the position of the cooling end is a position above a horizontal plane, the first posture information is positive direction information representing that the relative position relationship information of the heat source end and the condensing end is in a positive direction;
when the position of the heat source end relative to the position of the cooling end is a position under a horizontal plane, the first posture information is negative direction information representing that the relative position relationship information of the heat source end and the condensing end is in a negative direction.

4. The method according to claim 3, wherein when the first posture information is the negative direction information, the step of determining the first cooling efficiency corresponding to the first posture information based on the correspondence between the posture information and the cooling efficiency of the first cooling apparatus comprises a step of:
determining the first cooling efficiency corresponding to the negative direction information, based on the correspondence between the negative direction information and the cooling efficiency of the first cooling apparatus.

5. The method according to claim 4, wherein the step of deciding whether the first actual power is larger than first standard power of the first heating element corresponding to the first cooling efficiency so as to obtain a decision result comprises steps of:
obtaining the first standard efficiency of the first heating element corresponding to the first cooling efficiency;
deciding whether the first actual power is larger than the first standard power, so as to obtain the decision result.

6. The method according to claim 5, wherein when the first cooling efficiency is a maximum cooling power of the first cooling apparatus, the step of obtaining the first standard power of the first heating element corresponding to the first cooling efficiency comprises a step of:
obtaining the first standard power of the first heating element corresponding to the maximum cooling power by looking up in a correspondence table between the cooling power and the standard power of the first heating element.

7. The method according to claim 6, wherein the step of adjusting the power of the first heating element from the first actual power to the first standard power when the decision result indicates that the first actual power is larger than the first standard power comprises steps of:
deciding whether the first actual power is less than the maximum cooling power when the decision result indicates that the first actual power is larger than the first standard power;
adjusting the power of the first heating element from the first actual power to the first standard power when the first actual power is less than the maximum cooling power.

8. An electronic device comprising a first heating element and a first cooling apparatus, the electronic device further comprising:
a detection and obtaining unit, configured to detect and obtain, at a first instant, first posture information indicating that the electronic device is in a first posture; and to detect and obtain first actual power of the first heating element;
a determination unit, configured to determine first cooling efficiency corresponding to the first posture information based on a correspondence between the posture information and cooling efficiency of the first cooling apparatus;
a decision unit, configured to decide whether the first actual power is larger than first standard power of the first heating element corresponding to the first cooling efficiency, so as to obtain a decision result;
an adjustment unit, configured to adjust power of the first heating element from the first actual power to the first standard power when the decision result indicates that the first actual power is larger than the first standard power.

9. The electronic device according to claim 8, wherein the first cooling apparatus further comprises:
a heat source end;
a condensing end, connected to the heat source end;
wherein the first posture information is relative position relationship information of the heat source end and the cooling end at the first instant.

10. The electronic device according to claim 9, wherein when a position of the heat source end relative to a position of the cooling end is a position above a horizontal plane, the first posture information is positive direction information representing that the relative position relationship information of the heat source end and the condensing end is in a positive direction;
when the position of the heat source end relative to the position of the cooling end is a position under a horizontal plane, the first posture information is negative direction information representing that the relative position relationship information of the heat source end and the condensing end is in a negative direction.

11. The electronic device according to claim 10, wherein when the first posture information is the negative direction information, the determination unit is further configured to
determine the first cooling efficiency corresponding to the negative direction information based on the correspondence between the negative direction information and the cooling efficiency of the first cooling apparatus.

12. The electronic device according to claim 8, wherein the decision unit further comprises:
a first obtaining unit, configured to obtain the first standard efficiency of the first heating element corresponding to the first cooling efficiency;
a first decision sub-unit, configured to decide whether the first actual power is larger than the first standard power, so as to obtain the decision result.

13. The electronic device according to claim 8, wherein when the first cooling efficiency is a maximum cooling power of the first cooling apparatus, the first obtaining unit is particularly configured to:
obtain the first standard power of the first heating element corresponding to the maximum cooling power by looking up in a correspondence table between the cooling power and the standard power of the first heating element.

14. The electronic device according to claim 8, wherein the adjustment unit further comprises:
a first decision sub-unit, configured to decide whether the first actual power is less than the maximum cooling power when the decision result indicates that the first actual power is larger than the first standard power;
a first adjustment sub-unit, configured to adjust the power of the first heating element from the first actual power to the first standard power when the first actual power is less than the maximum cooling power.
